(19) United States
(12) Patent Application Publication
(10) Pub. No.: US 2022/0372304 A1
(43) Pub. Date: Nov. 24, 2022

(54) SILICONE ELASTOMERIC COATING

(71) Applicant: DOW SILICONES CORPORATION, Midland, MI (US)

(72) Inventors: Mark D. FISHER, Midland, MI (US); Jarred Q. CRAMTON, Denver, CO (US); Brian J. SWANTON, Saginaw, MI (US); Timothy MORLEY, Midland, MI (US)

(21) Appl. No.: 17/621,653

(22) PCT Filed: Jun. 26, 2020
(86) PCT No.: PCT/US2020/039719

§ 371 Date: Dec. 21, 2021

Related U.S. Application Data
(60) Provisional application No. 62/867,436, filed on Jun. 27, 2019.

(51) Int. Cl. C09D 5/33; C09D 7/61; C09D 183/04; C09D 163/00; C09D 133/08; C09D 133/10; C08K 3/36

(52) U.S. Cl. CPC C09D 5/004; C09D 7/61; C09D 183/04; C09D 163/00; C09D 133/08; C09D 133/10; C08K 3/36

(57) ABSTRACT

A hydrosilylation curable silicone elastomeric coating composition, which generally has a low viscosity to be self-leveling and/or which is designed for coating transparent substrates (such as glass) is provided, as well as a coated article comprising a substrate coated with a silicone elastomeric coating and the preparation and use thereof. The composition comprises: (i) at least one polydiorganosiloxane polymer having a viscosity of from 0.10 to 1,000 Pa.s at 25° C. and having at least two alkenyl and/or alkynyl groups per molecule; (ii) reinforcing filler comprising an MQ resin and optionally silica; (iii) an organohydrogenpolysiloxane having at least two silicon-bonded hydrogen atoms per molecule; (iv) a hydrosilylation catalyst; and (v) an adhesion promoter.

This disclosure identifies a hydrosilylation curable silicone elastomeric coating composition, which preferably has a sufficiently low viscosity to be self-leveling, as well as a coated article comprising a substrate coated with a silicone elastomeric coating and the preparation and use thereof. In one alternative the substrate utilised is glass.

Substrates such as glass are being increasingly used in modern architecture in a wide assortment of guises e.g. in facades, roofing, spandrels, shadow boxes and is used for both structural and/or decorative purposes. Glass, for example, is often utilised in the form of flat panels, which may be colored and/or provided with coatings which may be decorative and/or functional c.a. for increasing reflection capacity and/or infrared range and/or UV range. These coatings can be applied onto the e.g. glass substrates via a wide variety of methods e.g. by way of vapor-deposition, although such coatings may require expensive preparation before coating can take place.

The use of curable silicone elastomeric compositions for coating substrates such as glass substrates are known. They can be applied for a variety of reasons such as protection, reinforcement, and for decorative effect. However, the majority of such industrially available coating compositions are applied in solvent-form and to date a large proportion of suitable organic solvents for diluting silicone-based coating compositions can contain volatile organic compounds (VOCs), requiring measures to protect both workers and the environment not least because many are chemically unstable at higher temperatures. Furthermore, such coating compositions tend to produce weak elastomeric coatings with low tear strength and poor adhesion making the application of further components onto the coated glass surface problematic.

Typically, many silicone-based coatings, e.g. coatings suitable for application on substrates such as decorative glass, rely on the deposition of a water-based silicone coating. However, these water-based products often only generate a weak elastomeric coating that has low tear strength and poor adhesion, particularly in hot and humid conditions. This results in coatings that are unsuitable for affixing secondary components to the substrate such as decorative coated glass substrate due to their lack of suitability.

Hence, there remains a need in the industry for coatings for application to substrates such as glass that can render the same opaque and/or impart a large spectrum of colors thereto and/or can provide sufficient adhesive qualities to bond to secondary components whilst maintaining low coating thicknesses.

There is provided a hydrosilylation curable silicone elastomeric coating composition comprising

(i) one or more polydiorganosiloxane polymer(s) having a viscosity of from 0.10 to 1,000 Pa.s at 25° C. containing at least two alkenyl and/or alkynyl groups per molecule measured using a Brookfield LV CP-52 viscometer at 3 rpm;

(ii) a reinforcing filler comprising an MQ resin in an amount of from 5 to 37 wt. % of the composition and optionally silica in an amount of 0 to 20 wt. % of the composition and wherein the total wt. % of reinforcing filler present is from 5 to 40%;

(iii) an organohydrogenpolysiloxane, having at least 2, alternatively at least 3 silicon-bonded hydrogen atoms per molecule in an amount such that the molar ratio of Si-H alkenyl is ≥1:1; alternatively, ≥1.5:1;

(iv) a hydrosilylation catalyst;

(v) an adhesion promoter; and optionally one or more additives selected from adhesion catalysts, pigments, particulate opacifiers and/or hydrosilylation cure inhibitors; which composition has a viscosity of from 1 to 100 Pa.s as measured at 10.0 s⁻¹ using a parallel plate configuration on a TA Instruments AR2000 rheometer at a temperature of 25° C.

There is also provided a coated article comprising a substrate coated with a cured coating of the above composition. In one alternative the substrate is a glass substrate.

There is also provided the use of a hydrosilylation curable silicone elastomeric coating composition comprising

(i) one or more polydiorganosiloxane polymer(s) having a viscosity of from 0.10 to 1,000 Pa.s at 25° C. containing at least two alkenyl and/or alkynyl groups per molecule measured using a Brookfield LV CP-52 viscometer at 3 rpm;

(ii) a reinforcing filler comprising an MQ resin in an amount of from 5 to 37 wt. % of the composition and optionally silica in an amount of 0 to 20 wt. % of the composition and wherein the total wt. % of reinforcing filler present is from 5 to 40%;

(iii) an organohydrogenpolysiloxane, having at least 2, alternatively at least 3 silicon-bonded hydrogen atoms per molecule in an amount such that the molar ratio of Si-H:alkenyl is ≥1:1; alternatively, ≥1.5:1;

(iv) a hydrosilylation catalyst;

(v) an adhesion promoter; and optionally one or more additives selected from adhesion catalysts, pigments, particulate opacifiers and/or hydrosilylation cure inhibitors; which composition has a viscosity of from 1 to 100 Pa.s as measured at 10.0 s using a parallel plate configuration on a TA Instruments AR2000 rheometer at a temperature of 25° C.;

in or as a hydrosilylation curable silicone elastomeric coating composition for coating a substrate, alternatively a hydrosilylation curable silicone elastomeric coating composition which is self-levelling and/or is for coating a transparent substrate such as glass.

There is provided a method of providing a substrate, alternatively a glass substrate, with a hydrosilylation cured elastomeric coating comprising mixing the ingredients of a hydrosilylation curable silicone elastomeric coating composition comprising

(i) one or more polydiorganosiloxane polymer(s) having a viscosity of from 0.10 to 1,000 Pa.s at 25° C. containing at least two alkenyl and/or alkynyl groups per molecule measured using a Brookfield LV CP-52 viscometer at 3 rpm;

(ii) a reinforcing filler comprising an MQ resin in an amount of from 5 to 37 wt. % of the composition and optionally silica in an amount of 0 to 20 wt. % of the composition and wherein the total wt. % of reinforcing filler present is from 5 to 40%;

(iii) an organohydrogenpolysiloxane, having at least 2, alternatively at least 3 silicon-bonded hydrogen atoms per molecule in an amount such that the molar ratio of Si—H alkenyl is 1:1; alternatively, ≥1.5:1;

(iv) a hydrosilylation catalyst;

(v) an adhesion promoter; and optionally one or more additives selected from adhesion catalysts, pigments, particulate opacifiers and/or hydrosilylation cure inhibitors; which composition has a viscosity of from 1 to 100 Pa.s as measured at 10.0 s¹ using a parallel plate configuration on a TA Instruments AR2000 rheometer at a temperature of 25° C., applying the resulting mixed composition onto a substrate, alternatively a transparent substrate such as glass and curing the composition.

There is also provided a coated article, alternatively a coated glass article obtainable or obtained by coating a substrate, alternatively a glass substrate, using the above method.

The hydrosilylation curable silicone elastomeric coating composition described herein may be a low viscosity, self leveling coating composition which upon cure provides a durable, non-toxic, elastomeric film on substrates and is particularly preferred for use with glass substrates. The cured silicone elastomeric coating provides excellent elastomeric physical properties that can render an e.g., glass substrate opaque and/or impart a large spectrum of colors thereto and/or provide sufficient adhesive qualities to enable the bonding of secondary components to the coating surface whilst maintaining low coating thicknesses. For the avoidance of doubt a self-leveling coating herein shall be construed to mean a coating composition that prior to cure flows to provide a smooth and uniform surface when applied onto a substrate. Typical silicone elastomer compositions that are used for other applications such as o-rings, gaskets, cookware, etc. are comparatively high viscosity materials prior to application on a substrate and cure. Such materials are not suitable for providing thin self-levelling coatings on e.g. transparent substrates such as glass, e.g. for decorative glass coatings due to the higher viscosity effectively preventing the ability of the composition to self-level when applied onto a substrate surface such as the aforementioned transparent substrate such as a decorative glass surface. To provide an improved coating composition with such properties that the coating composition must use MQ resin as a reinforcing filler, suitable adhesion promotors and by doing so a suitable self-levelling coating composition may be provided.

Hence, the hydrosilylation curable silicone elastomeric coating composition as described herein may, because of its self-levelling ability, be applied as a thin coating of from e.g. several μm to several mm thickness of less to a suitable substrate such as the aforementioned transparent substrates, for example a glass substrate.

Component (i) of the hydrosilylation curable silicone elastomeric coating composition is one or more polydiorganosiloxane polymer(s) having a viscosity of from 0.1 to 100 Pa.s at 25° C. containing at least two alkenyl and/or alkynyl groups per molecule Polydiorganosiloxane polymer (i) has multiple units of the formula (I):

RₐSiO₍₄−a)/2 (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups and/or boron containing groups. The subscript “a” may be 0, 1, 2 or 3, but is typically mainly 2 or 3.

Siloxy units may be described by a shorthand (abbreviated) nomenclature, namely-“M,” “D,” “T,” and “Q”, when R′ is e.g. a methyl group (further teaching on silicone nomenclature may be found in Walter Noll, Chemistry and Technology of Silicones, dated 1962, Chapter I, pages 1-9). The M unit corresponds to a siloxy unit where a=3, that is R′₃SiO_{1/2}; the D unit corresponds to a siloxy unit where a=2, namely R′₂SiO_{2/2}; the T unit corresponds to a siloxy unit where a=1, namely R′₁SiO_{3/2}; the Q unit corresponds to a siloxy unit where a=0, namely SiO_{4/2}.

Examples of typical groups on the polydiorganosiloxane polymer (i) include mainly alkenyl, alkyl, and/or aryl groups. The groups may be in pendent position (on a D or T siloxy unit) or may be terminal (on an M siloxy unit). As previously indicated alkenyl and/or alkynyl groups are essential. Hence, suitable alkenyl groups in polydiorganosiloxane polymer (i) typically contain from 2 to 10 carbon atoms, e.g., vinyl, isopropenyl, allyl, and 5-hexenyl.

The silicon-bonded organic groups attached to polydiorganosiloxane polymer (i) other than alkenyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with groups that do not interfere with curing of this inventive composition, such as halogen atoms. Preferred species of the silicon-bonded organic groups are, for example, alkyl groups such as methyl, ethyl, and propyl; and aryl groups such as phenyl.

The molecular structure of polydiorganosiloxane polymer (i) is typically linear, however, there can be some branching due to the presence of T units (as previously described) within the molecule.

The viscosity of polydiorganosiloxane polymer (i) should be at least 0.1 Pa.s at 25° C. The upper limit for the viscosity of polydiorganosiloxane polymer (i) is limited to a viscosity of up to 100 Pa.s at 25° C. using a Brookfield LV CP-52 viscometer at 3 rpm.

Generally, the or each polydiorganosiloxane containing at least two silicon-bonded alkenyl groups and/or alkynyl groups per molecule of component (i) has a viscosity of from 0.1 Pa.s to 100 Pa.s at 25° C., alternatively from 0.2 Pa.s to 60 Pa.s, alternatively from 0.2 Pa.s to 20 Pa.s at 25° C., alternatively from 0.2 Pa.s to 10 Pa.s at 25° C., alternatively from 0.2 Pa.s to 6 Pa.s at 25° C. measured using a Brookfield LV CP-52 viscometer at 3 rpm unless otherwise indicated.

The polydiorganosiloxane polymer (i) may be selected from polydimethylsiloxanes, alkylmethylpolysiloxanes, alkylarylpolysiloxanes or copolymers thereof containing e.g. alkenyl and/or alkynyl groups and may have any suitable terminal groups, for example, they may be trialkyl terminated, alkenyldialkyl terminated or may be terminated with any other suitable terminal group combination providing each polymer contains at least two alkenyl groups per molecule. Hence the Polydiorganosiloxane polymer (i) may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

For example, a polydiorganosiloxane polymer (i) containing alkenyl groups at the two terminals may be represented by the general formula (II):

R′R″R′″SiO—(R″R′″SiO)ₘ-SiOR″′R″R′ (II)

In formula (II), each R′ may be an alkenyl group or an alkynyl group, which typically contains from 2 to 10 carbon atoms. Alkenyl groups include but are not limited to vinyl, propenyl, butenyl, pentenyl, hexenyl an alkenylated cyclohexyl group, heptenyl, octenyl, nonenyl, decenyl or similar linear and branched alkenyl groups and alkenylated aromatic ringed structures. Alkynyl groups may be selected from but are not limited to ethynyl, propynyl, butynyl, pentynyl, hexynyl an alkynylated cyclohexyl group, heptynyl, octynyl, nonynyl, decynyl or similar linear and branched alkenyl groups and alkenylated aromatic ringed structures.

R″ does not contain ethylenic unsaturation, Each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of this inventive composition, such as halogen atoms. R′″ is R′ or R″.

Organopolysiloxane polymer (i), is typically present in an amount of from 5 to 85 wt. % of the composition, alternatively from 40 to 75 wt. % of the composition, alternatively from 45 to 75 wt. % of the composition.

Component (ii) of the composition is a reinforcing filler comprising an MQ resin in an amount of from 5 to 37 wt. % of the composition and optionally silica in an amount of 0 to 20 wt. % of the composition and wherein the total wt. % of reinforcing filler present is from 5 to 40%.

The reinforcing filler (ii) comprises an MQ resin based on the nomenclature discussed previously. Any suitable MQ resin may be utilised. Typically, MQ resins comprises R₃²SiO_{1/2} (M) siloxane units and SiO_{4/2} (Q) siloxane units, wherein the molar ratio of the R₃²SiO_{1/2} siloxane units to SiO_{4/2} siloxane units has a value of from 0.5:1 to 1.2:1, alternatively 0.6:1 to 1.1:1, wherein R² denotes a monovalent radical selected from hydrocarbon radicals, preferably having less than 20 carbon atoms and, most preferably, having from 1 to 10 carbon atoms. Examples of suitable R² radicals include alkyl radicals, such as methyl, ethyl, propyl, pentyl, octyl, undecyl and octadecyl; cycloaliphatic radicals, such as cyclohexyl; aryl radicals such as phenyl, tolyl, xylyl, benzyl, alpha-methyl styryl and 2-phenylethyl; alkenyl radicals such as vinyl; and chlorinated hydrocarbon radicals such as 3-chloropropyl and dichlorophenyl.

Preferably, at least 50%, alternatively at least 60% of R² groups in said MQ resins are alkyl groups and/or aryl groups and the remainder are alkenyl, particularly vinyl groups. Examples of preferred unreactive R₃SiO_{1/2} (M) siloxane units include Me₃SiO_{1/2}, PhMe₂SiO_{1/2} and Ph₂MeSiO_{1/2}, where Me hereinafter denotes methyl and Ph hereinafter denotes phenyl. Alternatively, the M groups may contain vinyl groups such as ViMe₂SiO_{1/2}, ViPh₂SiO₁₂, Vi₂MeSiO_{1/2}, Vi₂PhSiO_{1/2} groups.

In one embodiment the MQ resin. The MQ resin includes a resinous portion wherein the R₃²SiO_{1/2} siloxane units (i.e. M units) are bonded to SiO_{4/2} siloxane units (i.e. Q units) and each of Q group is bonded to at least one other SiO_{4/2} siloxane unit. The molar ratio of M units to Q units is from 0.5:1 to 1.2:1, alternatively 0.6:1 to 1.1:1, and the resin contains an average of from 2.5 to 7.5 mole percent of alkenyl groups. The alkenyl and/or alkynyl content of polymer (i) is determined using quantitative infra-red analysis in accordance with ASTM E168. The MQ resin may have a number-average molecular weight of from 2,000 to 5,000 g/mol. Synthetic polymers invariably consist of a mixture of macromolecular species with different degrees of polymerization and therefore of different molecular weights. There are different types of average polymer molecular weight, which can be measured in different experiments. The two most important are the number average molecular weight (Mn) and the weight average molecular weight (Mw). The Mn and Mw of a silicone polymer can be determined by Gel permeation chromatography (GPC) with precision of about 10-15%. This technique is standard and yields Mw, Mn and polydispersity index (PI). The degree of polymerisation (DP)=Mn/Mu where Mn is the number-average molecular weight coming from the GPC measurement and Mu is the molecular weight of a monomer unit. PI=Mw/Mn. The DP is linked to the viscosity of the polymer via Mw, the higher the DP, the higher the viscosity.

The MQ resin may consist essentially of M groups of the structure

R₂³R⁴SiO_{1/2}

and SiO_{4/2} units wherein each R³ is independently selected from the group consisting of monovalent hydrocarbon and monovalent halogenated hydrocarbon groups free of aliphatic unsaturation, R⁴ is selected from the group consisting of R³ and alkenyl groups, the mole ratio of R³ 2 R⁴Si01/2 units to SiO_{4/2} units is from 0.5:1 to 1.2:1, alternatively 0.6:1 to 1.1:1, and the resin contains an average of from 2.5 to 7.5 mole percent of alkenyl groups determined using quantitative infra-red analysis in accordance with ASTM E168. In one alternative each R³ is monovalent hydrocarbon and monovalent halogenated hydrocarbon groups free of aliphatic unsaturation, alternatively is an alkyl group having from 1 to 6 carbons, alternatively an alkyl group having 1 to 4 carbons, alternatively an alkyl group having 1 or 2 carbons, alternatively methyl. R⁴ is selected from the group consisting of R³, alkynyl groups and alkenyl groups, providing the MQ resin contains an average of from 2.5 to 7.5 mole percent of alkenyl and/or alkynyl groups determined using quantitative infra-red analysis in accordance with ASTM E168; alternatively, alkenyl groups, alternatively, alkenyl groups having from 2 to 6 carbons, alternatively vinyl.

Component (ii) the reinforcing filler may also comprise finely divided forms of silica, e.g. fumed silica and/or precipitated silica. Fumed silica and/or precipitated silica are the two of the preferred silica reinforcing fillers (ii), when present because of their relatively high surface area, which is typically at least 50 m²/g (BET method in accordance with ISO 9277:2010). Fillers having surface areas of from 50 to 450 m²/g (BET method in accordance with ISO 9277:2010), alternatively of from 50 to 300 m²/g (BET method in accordance with ISO 9277:2010), are typically used. Both types of silica are commercially available.

Silica reinforcing fillers (ii) are generally naturally hydrophilic (e.g. untreated silica fillers) and are therefore often treated with a treating agent to be rendered hydrophobic. These surface modified reinforcing fillers (ii) do not clump and can be homogeneously incorporated into polydiorganosiloxane polymer (i) as the surface treatment makes the fillers easily wetted by polydiorganosiloxane polymer (i). This results in improved room temperature mechanical properties of the compositions and resulting cured materials cured therefrom.

The surface treatment of the silica reinforcing fillers (ii) may be undertaken prior to introduction in the composition or in situ (i.e. in the presence of at least a portion of the other components of the composition herein by blending these components together at room temperature or above until the filler is completely treated. Typically, untreated silica reinforcing filler (ii) is treated in situ with a treating agent in the presence of polydiorganosiloxane polymer (i), whereafter mixing a silicone rubber base material is obtained, to which other components may be added.

Typically silica reinforcing filler (ii) may be surface treated with any low molecular weight organosilicon compounds disclosed in the art applicable to prevent creping of organosiloxane compositions during processing. For example, organosilanes, polydiorganosiloxanes, or organosilazanes e.g. hexaalkyl disilazane, short chain siloxane diols or fatty acids or fatty acid esters such as stearates to render the filler(s) hydrophobic and therefore easier to handle and obtain a homogeneous mixture with the other components. Specific examples include but are not restricted to silanol terminated ViMe siloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating units of diorganosiloxane in each molecule, hexaorganodisiloxane, hexaorganodisilazane. A small amount of water can be added together with the silica treating agent(s) as processing aid.

As previously indicated Component (ii) of the composition the reinforcing filler comprises an MQ resin in an amount of from 5 to 37 wt. % of the composition and optionally silica in an amount of 0 to 20 wt. % of the composition and wherein the total wt. % of reinforcing filler present is from 5 to 40%. In one alternative the MQ resin based reinforcing filler (ii) is preferably present in an amount of from 5-25 wt. % of the composition, alternatively from 10-20 wt. %. In cases where there is a mixture of powdered silica, e.g. fumed silica and MQ resin there must be a minimum of 5 wt. % of the mixture and a maximum of 40 wt. % of the mixture, or any combination therebetween providing the total amount of reinforcing filler (ii) is within the ranges discussed above. For example, there may be a mixture of up to 15 wt. % of fumed silica and up to 25 wt. % of the MQ resin, or alternatively of up to 20 wt. % of fumed silica and up to 20 wt. % of the MQ resin or any other combination providing the cumulative maximum is 40 wt. %.

In one embodiment there may be from 5 to 15 wt. % of fumed silica and from 5 to 20 wt. % of MQ resin, alternatively, from 5 to 12.5 wt. % of fumed silica and from 7.5 to 20 wt. % of MQ resin, present in the hydrosilylation curable silicone elastomeric glass coating composition. It was found that removing the MQ resins and substituting with more fumed silica compromised the self leveling properties and had a negative effect on adhesion to some substrates.

### Component (iii) Organohydrogenpolysiloxane

Component (iii) of the hydrosilylation curable silicone elastomeric glass coating composition is an organohydrogenpolysiloxane, which operates as a cross-linker for polymer (i), by the addition reaction of the silicon-bonded hydrogen atoms in component (iii) with the alkenyl groups in component (i) under the catalytic activity of component (iv) to be mentioned below. Organohydrogenpolysiloxane (iii) normally contains 3 or more silicon-bonded hydrogen atoms so that the hydrogen atoms of this component can sufficiently react with the alkenyl groups of component (i) to form a network structure therewith and thereby cure the composition.

The molecular configuration of organohydrogenpolysiloxane (iii) is not specifically restricted, and it can be straight chain, branch-containing straight chain, or cyclic. While the molecular weight of this component is not critical the number average molecular weight of the organohydrogenpolysiloxane will typically range from 194 g/mol to 7500 g/mol (determined by GPC as described above) with a silicon bonded hydrogen content ranging from 0.05 to 1.67 wt. % based Si²⁹NMR characterization.

Examples of organohydrogenpolysiloxane (iii) include but are not limited to:
1,1,3,3-tetramethyldisiloxane,
1,3,5,7-tetramethylcyclotetrasiloxane,
tris(hydrogendimethylsiloxy)methylsilane,
tris(hydrogendimethylsiloxy)phenylsilane, methylhydrogencyclopolysiloxane,
trimethylsiloxy-endblocked methylhydrogenpolysiloxane,
trimethylsiloxy-endblocked dimethylsiloxane/methylhydrogensiloxane copolymers,
dimethylhydrogensiloxy-endblocked dimethylpolysiloxane,
dimethylhydrogensiloxy-endblocked dimethylsiloxane/methylhydrogensiloxane copolymers,
trimethylsiloxy-endblocked methylhydrogensiloxane/diphenylsiloxane copolymers,
trimethylsiloxy-endblocked methylhydrogensiloxane/diphenylsiloxane/-dimethylsiloxane copolymers,
trimethylsiloxy-endblocked methylhydrogensiloxane/methylphenylsiloxane/-dimethylsiloxane copolymers,
dimethylhydrogensiloxy-endblocked methylhydrogensiloxane/dimethylsiloxane/-diphenylsiloxane copolymers,
dimethylhydrogensiloxy-endblocked methylhydrogensiloxane/dimethylsiloxane/-methylphenylsiloxane copolymers,
copolymers and/or silicon resins consisting of (CH₃)₂HSiO_{1/2} units, (CH₃)₃SiO_{1/2} units and SiO_{4/2} units,
copolymers and/or silicone resins consisting of (CH₃)₂HSiO_{1/2} units and SiO_{4/2} units, copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.

Component (iii) is typically present in the composition in an amount of from 5 to 12%, alternatively from 5 to 10 wt. % of the composition but the amount present is typically determined by the molar ratio of the silicon-bonded hydrogen atoms in component (iii) to the total number of all unsaturated groups, e.g. alkenyl and alkynyl groups, often vinyl groups. In the present composition this ratio is greater or equal to (≥) 1:1; alternatively.≥1.5:1; alternatively, >2:1; alternatively, from >2:1; to 20:1. The Si-H content of cross-linker (iii) is determined using quantitative infra-red analysis in accordance with ASTM E168.

### iv) Hydrosilylation Catalyst

As hereinbefore described the hydrosilylation curable silicone elastomeric glass coating composition is cured via a hydrosilylation reaction catalysed by a hydrosilylation (addition cure) catalyst (iv) that is a metal selected from the platinum metals, i.e. platinum, ruthenium, osmium, rhodium, iridium and palladium, or a compound of such metals. The metals include platinum, palladium, and rhodium but platinum and rhodium compounds are preferred due to the high activity level of these catalysts for hydrosilylation reactions.

Example of preferred hydrosilylation catalysts (iv) include but are not limited to platinum black, platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. The catalyst (iv) can be platinum metal, platinum metal deposited on a carrier, such as silica gel or powdered charcoal, or a compound or complex of a platinum group metal.

Examples of suitable platinum-based catalysts (iv) include

(i) complexes of chloroplatinic acid with organosiloxanes containing ethylenically unsaturated hydrocarbon groups are described in U.S. Pat. No. 3,419,593;

(ii) chloroplatinic acid, either in hexahydrate form or anhydrous form;

(iii) a platinum-containing catalyst which is obtained by a method comprising reacting chloroplatinic acid with an aliphatically unsaturated organosilicon compound, such as divinyltetramethyldisiloxane;

(iv) alkene-platinum-silyl complexes as described in U.S. Pat. No. 6,605,734 such as (COD)Pt(SiMeCl₂)₂ where “COD” is 1,5-cyclooctadiene; and/or

(iv) Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (iv) is present in the total composition in a catalytic amount, i.e., an amount or quantity sufficient to promote a reaction or curing thereof at desired conditions. Varying levels of the hydrosilylation catalyst (iv) can be used to tailor reaction rate and cure kinetics. The catalytic amount of the hydrosilylation catalyst (iv) is generally between 0.01 ppm, and 10,000 parts by weight of platinum-group metal, per million parts (ppm), based on the combined weight of the components (i) and (ii) and (v) when present; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0 wt. % of the composition.

Component (v) of the hydrosilylation curable silicone elastomeric coating composition is an adhesion promoter. Any suitable adhesion promoter(s) may be utilised. These may comprise or consist of one or more alkoxysilanes containing methacrylic groups or acrylic groups and/or one or more alkoxysilanes containing epoxy groups and optionally one or more condensation catalyst which, when present, is used to activate and/or accelerate the reaction of the adhesion promoter (v).

Examples of alkoxysilanes containing methacrylic groups or acrylic groups such as methacryloxymethyl-trimethoxysilane, 3-methacryloxypropyl-tirmethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

Examples of epoxy-containing alkoxysilanes (v) may include 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyltriethoxysilane, 2-(3,4-epoxycyclohexyl)ethyltrimethoxysilane, or 2-(3,4-epoxycyclohexyl)ethyltriethoxysilane.

Adhesion catalysts, i.e. condensation catalysts used to activate and/or accelerate the reaction of the adhesion promoter (v) described above may also be utilised. Such condensation catalysts may be selected from organometallic catalysts comprising zirconates, titanates, organo aluminum chelates, and/or zirconium chelates.

Zirconate and titanate based catalysts may comprise a compound according to the general formula Ti[OR⁵]₄ or Zr[OR⁵]₄ where each R⁵ may be the same or different and represents a monovalent, primary, secondary or tertiary aliphatic hydrocarbon group which may be linear or branched containing from 1 to 20 carbon atoms, alternatively 1 to 10 carbon atoms. Optionally the zirconate may contain partially unsaturated groups. Preferred examples of R⁵ include but are not restricted to methyl, ethyl, propyl, isopropyl, butyl, tertiary butyl and a branched secondary alkyl group such as 2,4-dimethyl-3-pentyl. Preferably, when each R⁵ is the same, R⁵ is an isopropyl, branched secondary alkyl group or a tertiary alkyl group, in particular, tertiary butyl. Specific examples include but are not restricted to zirconium tetrapropylate and zirconium tetrabutyrate, tetra-isopropyl zirconate, zirconium (IV)tetraacetyl acetonate, (sometimes referred to as zirconium AcAc), zirconium (IV) hexafluoracetyl acetonate, zirconium (IV)trifluoroacetyl acetonate, tetrakis(ethyltrifluoroacetyl acetonate) zirconium, tetrakis(2,2,6,6-tetramethyl-heptanethionate) zirconium, zirconium (IV)dibutoxy bis(ethylacetonate), zirconium tributoxyacetylacetate, zirconium butoxyacetylacetonate bisethylacetoacetate, zirconium butoxyacetylacetonate hisethylacetoacetate, diisopropoxy bis(2,2,6,6-tetramethyl-heptanethionate) zirconium, or similar zirconium complexes having β3-diketones (including alkyl-substituted and fluoro-substituted forms thereof) which are used as ligands. The titanate equivalents of the above zirconates are also included herein.

Suitable aluminum-based condensation catalysts may include one or more of Al(OC₃H₇)₃, Al(OC₃H₇)₂(C₃COCH₂COC₁₂H₂₅),Al(OC₃H₇)₂(OCOCH₃), and Al(OC₃H₇)₂(OCOC₁₂H₂₅).

If deemed necessary and/or beneficial, the adhesion promoter may also include other ingredients such as other silane coupling agents, organic compounds containing two or more acrylate groups and/or reactive siloxanes.

Examples of organic compounds containing two or more acrylate groups include, e.g. diacrylates such as C₄₋₂₀ alkanediol diacrylate such as hexanediol diacrylate heptanediol diacrylate octanediol diacrylate nonanediol diacrylate and or undecanediol; and/or pentaerythritol tetraacrylate.

Examples of the reactive siloxanes include siloxanes such as hydroxy-terminated dimethyl-methylvinyl siloxane trimethylsiloxy-terminated methylhydrogen siloxane in each case optionally containing one or more perfluoroalkyl chains, such as trifluoropropyl or perfluorobutylethyl side chains. Typically, such siloxanes have a viscosity of from 0.001 to 0.1 Pa.S at 25° C., alternatively of from 0.001 to 0.05 Pa.S at 25° C.

The adhesion promoter is typically present in the composition in an amount of from about 0.1 to 6 wt. % of the composition; alternatively, 0.1 to 4 wt. % of the composition. It was found that whilst eliminating some of the adhesion promoter allows for more reinforcing filler (ii) to be introduced into the composition, complete elimination has a more significantly negative affect on adhesion performance of the coating composition.

### Additives

As previously indicated the hydrosilylation curable silicone elastomeric coating composition may comprise one or more additives selected from hydrosilylation cure inhibitors, pigments and/or particulate opacifiers.

### Inhibitor

For example, given the composition is cured via hydrosilylation, inhibitors designed to obtain a longer working time or pot life of the hydrosilylation curable silicone elastomeric coating composition may be incorporated into the composition in order to retard or suppress the activity of the catalyst.

Inhibitors of platinum metal-based catalysts, generally a platinum metal-based catalyst is well known in the art. Hydrosilylation or addition-reaction inhibitors include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargylalcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor concentrations as low as 1 mole of inhibitor per mole of the metal of catalyst (iv) will in some instances impart satisfactory storage stability and cure rate. In other instances, inhibitor concentrations of up to 500 moles of inhibitor per mole of the metal of catalyst (iv) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10 wt. % of the composition. Mixtures of the above may also be used.

A still further optional component of the hydrosilylation curable silicone elastomeric coating composition is/are one or more pigments. Any suitable pigment which is compatible with the of the hydrosilylation curable silicone elastomeric coating composition and is capable of rendering the same colored or substantially opaque. Preferred examples are aluminum oxide, iron oxides, titanium dioxide, chromium oxide, bismuth vanadium oxide, zinc oxide, clays, carbon black, phthalocyanines, and quinacridones and mixtures or derivatives thereof. Pigment may be present in the coating composition from 1.0 wt. % to 5.0 wt. %, preferably, 2.0 to 4.0 wt. % by weight of the composition.

Any suitable pigments may be utilised these include near infra-red (NIR) reflective pigments including metals such as aluminium (aluminium flake pigments), silver, gold, copper and silicon powder; metals with surface coatings such as AlO(OH) on aluminium, AgS on silver and metal coated cenosphere particles; metal oxides including nanocrystalline metal oxides and mixed metal oxides such as TiO₂e.g. rutile TiO₂, ZnO, red iron oxide (Fe₂O₃), Cr₂O₃, Sb₂O₃ZrO₂, CeO₂, MgO, Al₂O₃, ZnO and chromium iron oxide doped metal oxides such as TiO₂ doped with Al, Li, K, Nb, Sb, Bi and V; and other NIR reflective pigments such as Cadmium stannate (Cd2·SnO4), ZnS, an mica flakes. For the avoidance of doubt for the sake of this application the NIR region is between 700 and 2500 nm.

In the event of the end application requiring the coating to be opaque e.g. for a glass coating, a suitable opacifier may be included in the hydrosilylation curable silicone elastomeric glass coating composition. Any suitable opacifier may be utilised. For example, the particulate based opacifier may be selected from calcium carbonate or titanium dioxide. These particulates may be bare (hydrophilic) or have been rendered hydrophobic. For example, a calcium carbonate may be treated with any treating agent described for rendering a filler (ii) hydrophobic. Examples include common stearic acid and organosilanes. It will be noted that the opacifiers may be listed as non-reinforcing fillers below and as such if selected will function as both opacifier and non-reinforcing filler but for simplicity will be referred to as opacifiers.

Other examples of optional additives may include non-conductive filler, pot life extenders, flame retardants, colouring agents, chain extenders and mixtures thereof.

### Non-Reinforcing Filler

Non-reinforcing filler, when present, may comprise crushed quartz, diatomaceous earths, barium sulphate, iron oxide, titanium dioxide and carbon black, wollastonite and platelet type fillers such as, graphite, graphene, talc, mica, clay, sheet silicates, kaolin, montmorillonite and mixtures thereof. Other non-reinforcing fillers which might be used alone or in addition to the above include aluminite, calcium sulphate (anhydrite), gypsum, calcium sulphate, magnesium carbonate, aluminum trihydroxide, magnesium hydroxide (brucite), graphite, copper carbonate, e.g. malachite, nickel carbonate, e.g. zarachite, barium carbonate, e.g. witherite and/or strontium carbonate e.g. strontianite.

Non-reinforcing fillers when present may alternatively or additionally be selected from aluminum oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluminosilicates comprise ground silicate minerals, such as but not limited to, sillimanite; Al₂SiO₅; mullite; 3Al₂O₃.2SiO₂; kyanite; and Al₂SiO₅The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

Suitable sheet silicates e.g. silicate minerals which may be utilised include but are not limited to mica; K₂AI₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite. When present, the non-reinforcing filler(s) is/are present up to a cumulative total of from 1 to 50 wt. % of the composition,

In one embodiment the non-reinforcing filler may include glass or the like micro beads or microspheres to enhance the thermal insulation of the material. The micro beads or microspheres may be glass e.g. for example borosilicate glass micro-beads and/or microspheres.

Whenever deemed necessary the non-reinforcing filler may also be treated as described above with respect to the reinforcing fillers (ii) to render them hydrophobic and thereby easier to handle and obtain a homogeneous mixture with the other components. As in the case of the reinforcing fillers (ii) surface treatment of the non-reinforcing fillers makes them easily wetted by polydiorganosiloxane polymer (i) and resin (v) when present which may result in improved properties of the compositions, such as better processability (e.g. lower viscosity, better mold releasing ability and/or less adhesive to processing equipment, such as two roll mill), heat resistance, and mechanical properties.

Examples of non-conductive fillers include quartz powder, diatomaceous earth, talc, clay, mica, calcium carbonate, magnesium carbonate, hollow glass, glass fibre, hollow resin and plated powder, and mixtures or derivatives thereof.

Pot life extenders, such as triazole, may be used, but are not considered necessary in the scope of the present invention. The liquid curable silicone elastomer composition may thus be free of pot life extender.

Examples of flame retardants include aluminum trihydrate, magnesium hydroxide, calcium carbonate, zinc borate, wollastonite, mica and chlorinated paraffins, hexabromocyclododecane, triphenyl phosphate, dimethyl methylphosphonate, tris(2,3-dibromopropyl)phosphate (brominated tris), and mixtures or derivatives thereof.

Examples of colouring agents include vat dyes, reactive dyes, acid dyes, chrome dyes, disperse dyes, cationic dyes and mixtures thereof.

Examples of chain extenders include disiloxane or a low molecular weight polyorganosiloxane containing two silicon-bonded hydrogen atoms at the terminal positions. The chain extender typically reacts with the alkenyl groups and/or alkynyl groups of polydiorganosiloxane polymer (i), thereby linking two or more molecules of polydiorganosiloxane polymer (i) together and increasing its effective molecular weight and the distance between potential cross-linking sites.

A disiloxane is typically represented by the general formula (HR₂^{a}Si)₂O. When the chain extender is a polyorganosiloxane, it has terminal units of the general formula HR₂^{a}SiO_{1/2} and non-terminal units of the formula R₂^{b} SiO. In these formulae, R^{a} and R^{b} individually represent unsubstituted or substituted monovalent hydrocarbon groups that are free of ethylenic unsaturation, which include, but are not limited to alkyl groups containing from 1 to 10 carbon atoms, substituted alkyl groups containing from 1 to 10 carbon atoms such as chloromethyl and 3,3,3-trifluoropropyl, cycloalkyl groups containing from 3 to 10 carbon atoms, aryl containing 6 to 10 carbon atoms, alkaryl groups containing 7 to 10 carbon atoms, such as tolyl and xylyl, and aralkyl groups containing 7 to 10 carbon atoms, such as benzyl.

Further examples of chain extenders include tetramethyldihydrogendisiloxane or dimethylhydrogen-terminated polydimethylsiloxane.

Where the optional additives may be used for more than one reason e.g. as a non-reinforcing filler and flame retardant, when present, they may function in both roles. When or if present, the aforementioned additional components are cumulatively present in an amount of from 0.1 to 30 wt. %, alternatively of from 0.1 to 20 wt. %, based on the weight of the composition.

In order to prevent premature cure in storage, the composition are stored prior to use in two parts, generally referred to as Part A and part B. Typically, part A will contain some of polydiorganosiloxane polymer (i),reinforcing filler (ii), hydrosilylation catalyst (iii) and if present, adhesion catalyst and part B will contain the remainder of polydiorganosiloxane polymer (i), reinforcing filler (ii), adhesion promoter (v) together with components organohydrogenpolysiloxane (iii) and, if present, the inhibitor. The two-part composition may be designed to be mixed together in any suitable ratio, dependent on the amounts of polydiorganosiloxane polymer (i) and reinforcing filler (ii) in part B and as such can be mixed in a Part A:Part B weight ratio of from 15:1 to 1:1.

For example, when Part A and Part B are mixed in a 1:1 weight ratio shortly prior to use, Part A may comprise a blend of the following components:

(i) one or more polydiorganosiloxane polymer(s) having a viscosity of from 0.1 to 100 Pa.S at 25° C. containing at least two alkenyl and/or alkynyl groups per molecule in an amount of from 15 to 85 wt. % of the composition; alternatively, from 40 to 75 wt. % of the composition, alternatively from 45 to 75 wt. % of the composition;

(ii) a reinforcing filler comprising an MQ resin in an amount of from 5 to 37wt. % of the composition and optionally silica in an amount of 0 to 20 wt. % of the composition and wherein the total wt. % of reinforcing filler present is from 5 to 40% alternatively the total wt. % of reinforcing filler is from 5 to 30 wt. %. In some instances, the the total wt. % of reinforcing filler may be from 7.5 to 30 wt. %, alternatively, from 10 to 30 wt. % and alternatively, from 15 to 30 wt. % based on the weight of the Part A composition;

(iv) a hydrosilylation catalyst within the range of from 0.001 to 4.0 wt. % of the Part A composition; and optionally one or more additives selected from adhesion catalysts in an amount of from 0 to 2.0 wt. % of Part A and/or particulate opacifiers in an amount of from 0 to 30 wt. % of Part A, with the proviso that the total wt. % of the Part A composition being 100 wt. %.

Furthermore, Part B may comprise a blend of the following components:

(i) one or more polydiorganosiloxane polymer(s) having a viscosity of from 0.1 to 100 Pa.S at 25° C. containing at least two alkenyl and/or alkynyl groups per molecule in an amount of from 15 to 80 wt. % of the composition; alternatively, from 35 to 75 wt. % of the composition, alternatively, from 45-65 wt. % of the Part B composition;

(ii) a reinforcing filler comprising an MQ resin in an amount of from 5 to 37 wt. % of the composition and optionally silica in an amount of 0 to 20 wt. % of the composition and wherein the total wt. % of reinforcing filler present is from 5 to 40% alternatively the total wt. % of reinforcing filler is from 5 to 30 wt. %. In some instances, the the total wt. % of reinforcing filler may be from 7.5 to 30 wt. %, alternatively, from 10 to 30 wt. % and alternatively, from 15 to 30 wt. % based on the weight of the Part B composition.;

(iii) an organohydrogenpolysiloxane, having at least 2, alternatively at least 3 silicon-bonded hydrogen atoms per molecule in an amount such that the molar ratio of Si—H alkenyl is ≥1:1; alternatively, ≥1.5:1; e.g. in an amount of from 10 to 20 wt. % of Part B;

(v) an adhesion promoter from about 0.1 to 6 wt. % of the composition; alternatively, 0.1 to 5 wt. % of the part B composition; and optionally

one or more additives selected from particulate opacifiers in an amount of from 0 to 30 wt. of Part B; and/or hydrosilylation cure inhibitors in an amount of from 0 to 2 wt. % with the proviso that the total wt. % of the Part A composition being 100 wt. %.

When Part A and Part B are mixed together, the silicone rubber composition disclosed herein may comprise: Polydiogansiloxane (i) in an amount of 30 to 75 wt. % of the composition, reinforcing filler (ii) in an amount of from 5 to 40 wt. %, alternatively of from 5 to 30 wt. %, alternatively from 7.5 to 30 wt. % wt. % alternatively from 10 to 30 wt. % of the composition;

(iii) organohydrogenpolysiloxane in an amount of from 0.5 to 12.5 weight %, alternatively from 1 to 10 wt. %, alternatively from 2% to l0 wt. % of the composition, hydrosilylation catalyst (iv) in an amount of from 0.01 to 1% of the composition; composition (v) an adhesion promoter in in an amount of 0.2 to 5 wt. %, optional inhibitor may be present in an amount of from 0.0125 to 1.0 wt. % of the composition and a condensation catalyst in the amount of 0.1 to 2 wt. %, wherein the wt. % of the combined composition is 100%.

If required pigments may be introduced into the composition when parts A and B are being mixed together or alternatively may be present in either or both Parts A and B prior to mixing as required.

As previously described there is also provided a method of providing a substrate with a hydrosilylation cured elastomeric coating comprising mixing the ingredients of a hydrosilylation curable silicone elastomeric coating composition as hereinbefore described; applying the resulting mixed composition onto a substrate and curing the composition. In one embodiment the composition has the ability to provide a rapid cure at elevated temperature of at least 100° C. in 10 minutes or less, alternatively 5 minutes or less.

The substrate may be selected from a transparent substrate such as glass or alternative substrates such as nylon, epoxy resin, polyurethane, polyester or aluminum.

In one embodiment there is also provided a method of providing a transparent, e.g. glass substrate with a hydrosilylation cured elastomeric coating comprising mixing the ingredients of a hydrosilylation curable silicone elastomeric coating composition as hereinbefore described; applying the resulting mixed composition onto a glass substrate and curing the composition.

The Parts A and B parts of the composition may be prepared in any way suitable. Any mixing techniques and devices described in the prior art can be used for this purpose. The particular device to be used will be determined dependent on the viscosities of components and the final curable coating composition. Suitable mixers include but are not limited to paddle type mixers and kneader type mixers. Cooling of components during mixing may be desirable to avoid premature curing of the composition. Suitable parts A and B are prepared and then part A and part B are mixed together shortly prior to use. Dependent on the compositions of the relevant Parts the two parts will be mixed together in a preferred ratio. A preferred ratio for ease of mixing is a 1:1 wt. ratio of Part A to Part B. The two parts may be mixed using e.g. meter mix equipment which pumps, meters and mixes the two components without the incorporation of air.

The hydrosilylation curable silicone elastomeric coating composition as hereinbefore described may be applied onto suitable substrates such as transparent substrates e.g. glass, by spraying, brushing, or rolling or flooding and squeegeeing or application with a knife coater or the like or the substrate may in certain circumstances be coated by immersion in a bath of the hydrosilylation curable silicone elastomeric glass coating composition.

The mixed Parts A and B may be cured in a suitable heating means e.g. an oven using a temperature/time schedule to achieve sufficient adhesion and coating aging properties. The composition has the ability to provide a rapid cure at elevated temperature of at least 100° C. in 10 minutes or less, alternatively 5 minutes or less.

For example, the coating composition may be cured by heating at a temperature of between 100° and 200° C. for a suitable period e.g. for 2 to 10 minutes as required, alternatively at 150° C. for 5 minutes, or at a higher temperature e.g. between 160° C. and 190° C. for a shorter time may be suitable.

The coating composition may be applied at any suitable thickness e.g. from several mm to several μm in thickness, as required for the application concerned, for example it may be applied in a thickness in the range between 25 and 200 μm, alternatively in the range of between 25 and 125 μm as required for the end use and is designed to be self levelling.

Silicone elastomer compositions utilize Newtonian silicone polymers as fluids whilst relying on reinforcing particles to build mechanical strength. The use of reinforcing fillers leads to complex non-Newtonian rheological compositions. Such complex rheology materials are frequently characterized by measures of apparent viscosity (η=stress/strain rate) and dynamic rheology parameters (elastic modulus (G′), viscous modulus (G″) and tan δ=G″/G′).

When a material has been coated to a surface you now have gravitational force as the sole mode for applying a shear stress (s).η=s/strain rate Strain rate is V/H, where V is the velocity and equates to the displacement (D) in a unit of time (t). V=D/t. H is the height, or thickness of the sample being deformed.

One common characteristic from using reinforcing particles is reversible structuring, which are both rate and strain dependent (reversible transfer from a viscous to a flowable state). Hence, as strain and rate are increased, the material may move from behaving in an elastic manner to being more viscous. Conversely, as the strain and stress are decreased these materials are prone to restructuring. The extent of structuring is typified by the tan 6 value. Hence, when a material moves from a high viscous content to an elastic content, it is typified by this cross-over point, where the dominant characteristic moves from viscous to elastic at which point tan 6 goes from being>1 to <1. The ability for a composition such as hereinbefore described to self-level is greatest when tan δ is >1, and ƒ is low, i.e. <100 Pa.S.

Hence, within the same compositional chemistry, a low viscosity material flows further in the same time span under gravitational force. A coating with a low level of structuring is considered able to flow more effectively across a substrate due to its ability to self-level. In rheological terms, if a coating maintains a low viscosity (<100 Pa.$) and a tan 6>1a low level of structuring would be observed. However, for a coating with a high viscosity (>100 Pa.S) and a tan 6<1a high level of structuring and hence less flow would be expected.

A self-leveling coating as previously described, shall be construed to mean a coating composition that prior to cure flows to provide a smooth and uniform surface when applied onto a substrate. Rheologically, an ideal self-leveling coating is thus one that is able to flow across a substrate whilst adhering well once cured. These key attributes occur when a coating exhibits a low viscosity and tan 6>1 whilst, after curing, providing a high Peak Stress measured via a Lap Shear test.

The time for maintaining self levelling behavior is critical in the coating application such that the coating can wet out the substrate effectively prior to curing and being fixed in position. In this regard a tan 6>1 for at least 55 seconds would allow the mixed system to adequately flow in the allotted time available during a mass production scenario. This phase should also be followed by the ability of the formulation to provide a rapid cure at elevated temperature of e.g. at least 100° C. in 10 minutes or less.

When the hydrosilylation curable silicone elastomeric coating composition as described herein is a hydrosilylation curable silicone elastomeric coating composition for coating transparent substrates, especially glass substrates, the glass substrate onto which the composition is applied may be virtually any glass substrate for example, borosilicate glass, soda lime glass, silica glass, alkali barium glass, aluminosilicate glass, lead glass, phosphate glass, alkali borosilicate glass, xena glass and/or fluorosilicate glass. The substrate may alternatively be a pre-treated glass, for example, vacuum-deposited reflective metallic-coated plate glass which may be used in e.g., commercial building and architectural spandrel applications.

There is also provided a coated article comprising a substrate coated with a cured coating of the above hydrosilylation curable silicone elastomeric coating composition. The substrate may be glass, nylon, epoxy resin, polyurethane, polyester or aluminum.

When said substrate is made from glass the substrate may be may be for example, borosilicate glass, soda lime glass, silica glass, alkali barium glass, aluminosilicate glass, lead glass, phosphate glass, alkali borosilicate glass, xena glass and/or fluorosilicate glass. The substrate may alternatively be a pre-treated glass, for example, vacuum-deposited reflective metallic-coated plate glass which may be used in e.g., commercial building and architectural spandrel applications.

Such a glass substrate may be for use in a wide variety of applications, e.g. in or for optical glass, architectural glass, decorative glass, technical glass, construction glass such as structural glass, float glass, shatterproof glass, laminated glass, extra clean glass, chromatic glass, tinted glass, toughened glass, glass bricks, frosted glass and/or bulletproof glass.

The coating composition described herein, upon cure provides a durable, non-toxic, elastomeric film on substrates as described above, particularly glass substrates. The cured silicone elastomeric coating provides excellent elastomeric physical properties that can render substrates e.g. glass substrates opaque and/or impart a large spectrum of colors thereto and provides sufficient adhesive qualities to enable the bonding of secondary components to a coating surface whilst maintaining low coating thicknesses.

Hence, the glass coating produced using the composition and or method hereinbefore described can render the glass substrate opaque and impart a large spectrum of colors as and based on the compositions high adhesion to glass, said coating composition allows for bonding of secondary components such as electrical junction boxes and the like to the coating.

The following examples, illustrating the compositions and components of the compositions, elastomers, and methods, are intended to illustrate and not to limit the invention.

### EXAMPLES

A series of hydrosilylation curable compositions were prepared in two parts. The compositions of the Parts A and B compositions are depicted in Tables 1a and 1b respectively below.

TABLE 1a
Part A Compositions

| | Ex. 1 | Ex. 2 | Ex. 3 | Comp. 1 | Comp. 2 |
|---|---|---|---|---|---|
| | (wt. %) | (wt. %) | (wt. %) | (wt. %) | (wt. %) |
| Dimethylvinyl terminated | 65.46 | 65.46 | 65.46 | 65.46 | 70.82 |
| polydimethylsiloxane having a viscosity of 2 | | | | | |
| Pa · s at 25° C. | | | | | |
| Fumed silica | 6.29 | 6.29 | 6.29 | 6.29 | 12.4 |
| Trimethyl and dimethylvinyl silylated MQ | 10.68 | 10.68 | 10.68 | 10.68 | — |
| resin | | | | | |
| Tetra-isopropoxy titanate (TIPT) | 1.07 | 1.07 | 1.07 | 1.07 | 0.6 |
| Calcium Carbonate (stearate treated) | 15.5 | 15.5 | 15.5 | 15.5 | 15.18 |
| chloroplatinic acid divinyltetramethyl- | 1.00 | 1.00 | 1.00 | 1.00 | 1.00 |
| disiloxane complex (effectively 20 ppm | | | | | |
| catalytic Pt) polydimethylsiloxane having a | | | | | |
| viscosity of 0.45 Pa · s at 25° C. | | | | | |

TABLE 1b
Part B Compositions

| | Ex. 1 | Ex. 2 | Ex. 3 | Comp. 1 | Comp. 2 |
|---|---|---|---|---|---|
| | (wt. %) | (wt. %) | (wt. %) | (wt. %) | (wt. %) |
| Dimethylvinyl terminated | 48.54 | 49.05 | 49.28 | 49.75 | 53.56 |
| polydimethylsiloxane having a viscosity of | | | | | |
| 2 Pa · s at 25° C. | | | | | |
| Trimethyl silyl treated fumed silica | 6.09 | 6.15 | 6.18 | 6.24 | 12.4 |
| Trimethyl and dimethylvinyl end-capped | 11.35 | 11.46 | 11.51 | 11.63 | — |
| MQ resin | | | | | |
| Calcium Carbonate (stearate treated) | 14.9 | 15.04 | 15.11 | 15.26 | 14.9 |
| trimethylsilyl terminated poly(dimethyl, | 16.35 | 16.51 | 16.59 | 16.75 | 16.36 |
| methylhydrogen) siloxane, viscosity 0.03 | | | | | |
| Pa · s at 25° C. | | | | | |
| Glycidoxypropyltrimethoxysilane | 1.42 | 1.43 | | | 1.42 |
| Methacryloxypropyltrimethoxysilane | 0.96 | — | 0.97 | | 0.96 |
| bis dimethylhydroxy terminated, | 0.36 | 0.36 | 0.36 | 0.37 | 0.36 |
| dimethymethylvinyl siloxane, viscosity | | | | | |
| about 0.01 Pa · s at 25° C. | | | | | |
| 1-ethynyl-1-cyclohexanol (ETCH) | 0.03 | | | | 0.04 |

For each example the respective Parts A and B were prepared using a centrifugal mixer and were stored at room temperature for a period of 24 hours.

Parts A and B were then mixed together using the Example 1 composition and 2 mm thick test sheets were prepared by curing the samples at 120° C. for a period of 10 minutes. The elastomeric physical properties of samples were determined and average results are depicted in Table 2 below.

TABLE 2
Physical properties of Ex. 1

| Property | Test Method | Average Result |
|---|---|---|
| Elongation at break (%) | ASTM D412 Die C | 250 |
| Tensile strength (MPa) | ASTM D412 Die C | 2.5 |
| Shore A hardness | ASTM D2240 | 33.0 |

Respective Parts A and B were then mixed together for each example and the resulting mixture was applied by a standard draw down blade technique to produce a 150 μm coating on borosilicate glass substrates and the coated substrates were then placed in an oven and cured for 2 minutes at 150° C. Commercially, a roll coating process would efficiently transfer material from a trough across the roller and onto a glass substrate. It is desirable to have a lower viscosity, self-levelling composition to allow for high speed coating combined with rapid self-levelling followed by quick cure with instantaneous adhesion.

### Rheology Characterization

The rheology characterization of the inventive and comparative materials was generated using a parallel plate configuration on a TA Instruments AR2000 rheometer. The instrument was configured with the base being a Pelletier stage and the upper platen was a 40 mm diameter stainless steel plate. All characterizations were performed at 25° C.

Information was obtained using a 3-step sequence:

Step 1: a 5-minute shear break down of the coating: ω=6.28 rad/s (1 Hz), γ=50%;

Step 2, (which immediately starts at the completion of step 1) was the viscoelastic recovery: ω=6.28 rad/s (1 Hz), γ=0.5% strain and was measured for 30 minutes, used to measure the Tan δvalues.

These first two steps are representative of the deformation that a coating material is subjected followed by the dwell before being cured.

Step 3: Measures the continuous flow viscosity, using a controlled shear rate sweep ranging from 100 s⁻¹ down to 0.1s⁻¹ rates, in which:

η=shear stress/shear rate=σ/γ;

Tan δΔ=G″/G′;

η*=G*/ω; and

G*=[(G′)²+(G″)²]^{1/2} as previously discussed.

TABLE 3a
Rheology Performance

| Rheology Property | Ex. 1 | Ex. 2 | Ex. 3 | Comp. 1 | Comp. 2 |
|---|---|---|---|---|---|
| η at 0.1 s⁻¹ (Pa · s) | 153 | 142.1 | 136.6 | 44.2 | 497.4 |
| η at 1.0 s⁻¹ (Pa · s) | 20.4 | 19.9 | 19.4 | 10.8 | 68 |
| Tan δ at 55 s | 1.39 | 1.7 | 1.79 | 5.64 | 0.54 |
| Structuring level | low | low | low | low | high |

Given the composition when mixed has an apparent viscosity (η) of from 1 to 100 Pa.S as measured at 1.0 s⁻¹ using a parallel plate configuration on a TA Instruments AR2000 rheometer at a temperature of 25° C., the composition, pre-cure, is of a low enough viscosity to be considered self-levelling as hereinbefore described, with the coating composition being easily spread on a substrate surface such as a glass substrate surface. It was found that for the present composition η (i.e. shear stress/shear rate or σ/γ) was from 15 to 100 Pa.S measured at a shear rate of 1.0s⁻¹ and 25° C. Compositions made using our composition were also found to advantageously have Tan δ (i.e. viscous modulus/elastic modulus (G″/G′)) at a value of >1.0 for at least 55 seconds indicating a viscous-dominant (i.e. liquid-like) behaviour and as such is then better for flow as it will spread faster and further, hence having self-levelling properties. The coating exhibits a low viscosity and tan 6>1 whilst providing a high Peak Stress of >1.25 MPa measured via a Lap Shear test as described herein. The time for maintaining self levelling behavior is critical in the coating application such that the coating can wet out the substrate effectively prior to curing and being fixed in position. In this regard a tan 6>1 for at least 55 seconds allows the mixed system to adequately flow in the allotted time available during a mass production scenario.

Comparative example 1 has a low viscosity and high tan 6 making it suitable for making a self-levelling coating, yet without the use of adhesion promoters it suffers from adhesive failure at low stress levels. A composition such as comparative 2 that contains an adhesion package, yet relies purely on fumed silica for reinforcement, does not exhibit a self-levelling character and exhibits a tan 6<1 instantaneous after high shear has ceased. The removal of the MQ resin mean you require more silica to achieve reinforcement, and this alters the rheology making it not as good for a self-levelling coating. In contrast in Comparative 1 there is provided an example of the lack of an adhesion package allows for a good low viscosity self-levelling coating, yet it does not produce sufficient adhesion as demonstrated by the lower force, and combined adhesive/cohesive failure at the glass interface. This is because as indicated above, the shorter the time period a materials has a tan 6>1, the less the material will flow before the elastomeric component minimizes flow. So, comparative 2 actually drops below 1 prior to a data point being obtained. Essentially, the very first data point after thinning the material out by applying a high shear is a tan 6 of about 0.89 @ 18.5 s. So, the larger tan 6, and the longer it is greater than 1 for such a structuring material, the easier it is for the material to self-level and make a good coating from the aspect of being smooth.

The examples and comparative examples were then assessed with respect to their respective scratch and adhesive performance and the results are provided in Table 3b below.

### Scratch Off Failure

The scratch off failure results were achieved after applying a 0.0039″ (0.99 cm) thick coating layer to 0.25″ (0.635 cm) thick borosilicate glass slides purchased from McMaster-Carr. The layer was then cured and the scratch off force was measured<3 hours after application on to the slides. Excepting the fact that the process was done by hand ASTM D7027 was followed for these tests.

### Lap Shear Preparation

Lap shear testing was performed as a measure of the quality of the adhesion of the inventive coating to the targeted substrate. The protocol used as a variant of ASTM D1002. The variant was that rather than accessing the strength of an adhesive (or glue) to bond two similar substrates, this test was to quantify the strength of the inventive compositions to the targeted substrate of interest, which is the substrate that the coating was applied, per step 1 below.

The substrate of interest was borosilicate glass (101.8 mm×25.4 mm×3.2 mm) slide was placed in a jig for forming lap shear specimens. A 1.5g portion of adhesive (DOWSIL™ RBL-9694-45M from Dow Silicones Corporation) was applied on top of the coating, and a rectangular aluminum panel (101.8 mm×25.4 mm×1.6 mm) that was primed with DOWSIL™ 92-023 Primer (from Dow Silicones Corporation) was placed into the second half of the jig to form a lap shear joint. DOWSIL™ RBL-9694-45M is a cure in place gasket (CIPG) product that has high bonding strength. The assembly was place in 150° C. oven for 10 minutes and allowed to cool for 5 minutes prior removal of the test specimens. Bond lines of the adhesive were 1.4 mm+/−0.15 mm.

Step 1. Apply 150 μm coating to the substrate of interest (glass, nylon, aluminum, etc.) and cure.

Step 2. After 120 minutes and before 180 minutes, seat the coated specimen from step one into the lower portion of a lap shear jig.

Step 3. Apply a sufficient quantity of adhesive to overlap zone (25.4 mm×12.75 mm×1.62 mm).

Step 4. Apply a second substrate known to have excellent bonding to said adhesive and press to form bond line.

Step 5. Cure assembly.

Step 6. Lap shear force was measured at a crosshead speed of 50.8 mm/min using an MTS Alliance RF/100 Tensile Frame with MTS 2.5 kN load Cell.

TABLE 3b
Coating Adhesion Performance

| | Ex. 1 | Ex. 2 | Ex. 3 | Comp. 1 | Comp. 2 |
|---|---|---|---|---|---|
| Scratch off Failure (N) | 4.0 | 3.5 | 4.0 | 2.5 | 3.0 |
| Lap Shear Peak Stress | 1.492 | 1.684 | 2.257 | 0.922 | 1.558 |
| (MPa) | | | | | |
| Lap Shear Failure Mode | Adhesive | Adhesive | Adhesive | Adhesive/ | Adhesive/ |
| | | | | cohesive | cohesive |

### Description of Adhesive and Cohesive Failure

Adhesive—clean separation between two layers
Cohesive—failure within one of the elastomeric materials of interest
Adhesive/Cohesive—mixed failure that exhibit zones of clean adhesive failure along with cohesive failure in the elastomeric material
Adhesive failure Coating/CIPG=the failure occurs as a clean separation between the inventive or comparative coating and the applied adhesive. Hence, the coating to the glass remains intact, and the CIPG remains bonded with the aluminum panel.
Adhesive—Cohesive between coating and glass=specifically, the comparative coating adhesively delaminates from the glass slide and additionally cohesively tears within the bulk of the coating.

It can be seen from the results observed in Table 3b that a quality coating that has both good scratch resistance and adhesion strength is achievable when the inventive composition is used. Inventive samples 1-3 show how the combination of components create a flowable low viscosity formulation based on a combination of MQ resin, methacryloxypropyl silane, and/or glycidoxypropyltrimethoxysilane silane. These solutions provide sufficient resistance to incidental scratching force (<3N) and when necessary allow for attachments to be applied that would be estimated require high stresses (>1300 kPa) to adhesively remove the coating from the glass.

### Introduction of Near Infrared (NIR) Reflective Pigments

The function of a commercial NIR reflective pigment, Chrome Iron Brown Hematite (PBR29), available from Ferro Corporation, was assessed with respect to the composition of Ex.1 as identified in Tables 1a and 1b above.

The pigment used, PBR29, a dimethylvinyl terminated polydimethylsiloxane having a viscosity of about 450 mPa·s at 25° C. (hereafter referred to as “Polymer F”). The different compositions are identified in Table 4a below. were prepared as shown in Table 4a below together with a comparative using carbon black.

TABLE 4a
Composition of PBR29 pigment mixtures (wt. %)

| Composition | PBR29 | Carbon Black | Polymer 1 |
|---|---|---|---|
| PBR29 Mix 1 | 70 | | 30 |
| PBR29 Mix 2 | 70 | | 30 |
| PBR29 Mix 3 | 50 | | 50 |
| Comp Mix | | 20 | 80 |

The compositions of the part A formulation and the part B formulation were prepared as described above and the three components were mixed together in the combinations identified in Table 4b below.

TABLE 4b
compositions of com. 4 and Ex. 4-9 (wt. %)

| | PBR29 | PBR29 | PBR29 | Comp | Part A | Part B |
|---|---|---|---|---|---|---|
| | Mix 1 | Mix 2 | Mix 3 | Mix | (of Ex. 1) | (of Ex. 1) |
| Comp. 3 | | | | 9 | 45.5 | 45.5 |
| Ex. 4 | 9 | | | | 45.5 | 45.5 |
| Ex. 5 | 16.6 | | | | 41.7 | 41.7 |
| Ex. 6 | | 9 | | | 45.5 | 45.5 |
| Ex. 7 | | 16.6 | | | 41.7 | 41.7 |
| Ex. 8 | | | 9 | | 45.5 | 45.5 |
| Ex. 9 | | | 16.6 | | 41.7 | 41.7 |

The composition of each example was prepared by mixing the respective components. The resulting compositions were then applied onto sample glass substrates using a draw down bar to obtain a coating thickness on the glass substrate of approximately 150 microns. The coated glass was then cured in an oven at 150° C. for a period of 2 minutes. The % Reflectance of the coating was then taken and recorded at 1500 nm, using a Perkin Elmer Lambda 950 spectrophotometer with integrating sphere. % reflectance was measured from 300-2500 nm, in 2 nm step size, resulting in a spectrum being obtained in about a 4 minute period. The value at 1500 nm was taken and recorded for comparison as shown in Table 4c below. Coated samples are measured with the coated face measured first.

TABLE 4c
Reflectance results

| | % Reflectance of coating, value taken at 1500 nm |
|---|---|
| Comp. 3 | 1.5 |
| Ex. 4 | 70.8 |
| Ex. 5 | 70.5 |
| Ex. 6 | 65.1 |
| Ex. 7 | 71.8 |
| Ex. 8 | 59.3 |
| Ex. 9 | 58.8 |

It will be seen that the introduction of the PBR29 pigment into the formulations had a significant effect on the reflectance of the coatings, especially when compared with com. 3 using carbon black.

1. A hydrosilylation curable silicone elastomeric coating composition, comprising:
(i) one or more polydiorganosiloxane polymer(s) having a viscosity of from 0.10 to 1,000 Pa·s at 25° C. measured using a Brookfield LV CP-52 viscometer at 3 RPM, and having at least two alkenyl and/or alkynyl groups per molecule;
(ii) a reinforcing filler comprising an MQ resin in an amount of from 5 to 37_wt. % of the composition, and optionally silica in an amount of 0 to 20 wt. % of the composition, wherein the total wt. % of reinforcing filler present is from 5 to 40 wt. %;
(iii) an organohydrogenpolysiloxane, having at least 2, optionally at least 3 silicon-bonded hydrogen atoms per molecule in an amount such that the molar ratio of Si—H alkenyl is greater than or equal to 1:1; and optionally greater than or equal to 1.5:1;
(iv) a hydrosilylation catalyst; and
(v) an adhesion promoter; and optionally
one or more additives selected from the group consisting of adhesion catalysts, pigments, particulate opacifiers, and hydrosilylation cure inhibitors;
wherein the composition has a viscosity of from 1 to 100 Pa·s, as measured at 10.0 s⁻¹ using a parallel plate configuration on a TA Instruments AR2000 rheometer at a temperature of 25° C.

2. The hydrosilyiation curable silicone elastomeric coating composition in accordance with claim 1, wherein the silica of component (ii) is present and comprises fumed silica or precipitated silica.

3. The hydrosilyiation curable silicone elastomeric coating composition in accordance with claim 1, wherein component (ii) comprises the MQ resin and the silica.

4. The hydrosilylation curable silicone elastomeric coating composition in accordance with claim 1, wherein component (ii) comprises MQ resin in an amount of from 5 to 15wt. % of the composition.

5. The hydrosilylation curable silicone elastomeric coating composition in accordance with claim 1, further comprising an opacifier comprising calcium carbonate and/or titanium dioxide in an amount of from 5 to 25 wt. % of the composition.

6. The hydrosilylation curable silicone elastomeric coating composition in accordance with claim 1, wherein component (v) is one or more types selected from the group consisting of alkoxysilanes containing methacrylic groups or acrylic groups, and alkoxysilanes containing epoxy groups.

7. The hydrosilylation curable silicone elastomeric coating composition in accordance with claim 1, comprising one or more pigments and/or colorants in an amount of from 1.0 to 5.0 wt. % of the composition.

8. The hydrosilylation curable silicone elastomeric coating composition in accordance with claim 1, which is self-leveling.

9. The hydrosilylation curable silicone elastomeric coating composition in accordance with claim 8, wherein η is from 15 to 100 Pa·s measured at 1.0s⁻¹ and 25° C., Tan δ is >1.0 for at least 55 seconds, and the resulting coating has a lap shear peak stress of >1.25 MPa.

10. The hydrosilylation curable silicone elastomeric coating composition in accordance with claim 8, which is adapted to cure at a temperature of at least 100° C. in 10 minutes or less.

11. The hydrosilylation curable silicone elastomeric coating composition in accordance with claim 1, further comprising one or more near infrared reflective pigments.

12. A coated article comprising a substrate coated with a cured coating of the hydrosilylation curable silicone elastomeric coating composition in accordance with claim 1.

13. The coated article in accordance with claim 12, wherein the substrate is glass, nylon, epoxy resin, polyurethane, polyester, or aluminum.

14. A coated article in accordance with claim 12, wherein the substrate is borosilicate glass, soda lime glass, silica glass, alkali barium glass, aluminosilicate glass, lead glass, phosphate glass, alkali borosilicate glass, xena glass, fluorosilicate glass, or a pre-treated glass.

15. A method of providing a substrate with a hydrosilylation cured elastomeric glass coating, the method comprising mixing the components of the hydrosilylation curable silicone elastomeric coating composition in accordance with claim 1, applying the composition onto a substrate, and curing the composition.

16. A method of providing a substrate with a hydrosilylation cured elastomeric coating, the method comprising applying the hydrosilylation curable silicone elastomeric coating composition in accordance with claim 1, to the substrate, wherein the composition is applied by spraying, brushing, rolling, flooding, squeegeeing, knife coating, or immersion in a bath.

17. (canceled)

18. The coated article in accordance with claim 12, wherein the substrate is optical glass, architectural glass, decorative glass, technical glass, construction glass, structural glass, float glass, shatterproof glass, laminated glass, extra clean glass, chromatic glass, tinted glass, toughened glass, glass bricks, frosted glass and/or bulletproof glass.

19. A coated article obtainable or obtained by coating a substrate with hydrosilylation curable silicone elastomeric coating composition in accordance with claim 1, and curing the composition.
